(19) United States
(12) Patent Application Publication
(10) Pub. No.: US 2024/0146625 A1
(43) Pub. Date: May 2, 2024

(54) TELEMETRY INFORMATION NOTIFICATION APPARATUS, TELEMETRY INFORMATION NOTIFICATION METHOD AND TELEMETRY INFORMATION NOTIFICATION PROGRAM

(71) Applicant: Nippon Telegraph and Telephone Corporation, Tokyo (JP)

(72) Inventors: Takuya SATO, Musashino-shi, Tokyo (JP); Takamitsu NARUMI, Musashino-shi, Tokyo (JP); Takayuki NAKAMURA, Musashino-shi, Tokyo (JP); Mitsuo AMASAKA, Musashino-shi, Tokyo (JP)

(21) Appl. No.: 18/277,199

(22) PCT Filed: Feb. 16, 2021
(86) PCT No.: PCT/JP2021/005729

§ 371 Date: Aug. 14, 2023

(51) Int. Cl. H04L 41/5009; H04L 43/08

(52) U.S. Cl. CPC H04L 41/5009; H04L 43/08

(57) ABSTRACT

A node (100) includes a detection unit (122), an identification unit (123), and a determination unit (124). A detection unit (122) detects occurrence of a failure in a controller to which telemetry information in a slice is notified. An identification unit (123) identifies telemetry requirements of the slice when the detection unit (122) detects occurrence of the failure. A determination unit (124) determines whether to notify an alternative controller of the telemetry information in the slice in accordance with the telemetry requirements identified by the identification unit (123).

### TECHNICAL FIELD

The present disclosure relates to a telemetry information notification device, a telemetry information notification method, and a telemetry information notification program.

### BACKGROUND ART

An enterprise is expected to create a new service utilizing characteristics such as low delay and wide band in 5G. In using such a new service, SLA (Service Level Agreement) is important. The SLA is a mechanism for guaranteeing quality related to characteristics (for example, low delay, wide band) required for service.

In order to realize the SLA, it may be necessary to detect a decrease in communication quality or a sign of a decrease in communication quality. Further, it is necessary to execute control for improving the communication quality and confirm the communication state after the execution of the control. For this reason, the SLA may require measurement of telemetry information. The telemetry information is information related to various measurement items (for example, traffic amount, delay amount, jitter) related to communication quality.

The telemetry information is collected from a network. For example, the network includes a plurality of nodes. Each node periodically notifies a corresponding controller of the telemetry information (NPL 1).

A plurality of controllers is installed in the network, and the nodes are distributed and accommodated in the network. When a failure occurs in a certain controller, a node under the control of the controller changes a notification destination of the telemetry information from the controller to another controller, so that the telemetry information is relieved.

### CITATION LIST

### Non Patent Literature

[NPL 1] Takuya Satoh, and four others, “A proposal of effective telemetry information measurement and notification method using operational information”, Proceedings of the Society Conference of IEICE, September, 2020

### SUMMARY OF INVENTION

### Technical Problem

However, the above-described prior art may not relieve telemetry information with a small number of resources.

For example, in the technique of NPL 1, when a failure occurs in a certain controller, a node under the control of the controller directs a telemetry information to another controller. However, the processing impossibility of other controllers increases. This increase in processing impossibility may cause missing of the telemetry information.

Therefore, when a failure occurs in a certain controller, it is conceivable that the processing performance of other controllers has a sufficient margin so that the other controllers can relieve all telemetry information of nodes under the control of the controller. However, this leads to a wasteful cost at normal times.

Alternatively, it is conceivable to detect occurrence of a failure and generate a new controller. Also, it is also conceivable to temporarily enhance performance of other controllers. However, in this case, a time lag may occur until the new controller is generated or the performance of other controllers is enhanced. This may cause time during which the telemetry information is not temporarily acquired.

The present invention has been made to solve the above-described problems, and aims to relieve the telemetry information with a small number of resources.

### Solution to Problem

A telemetry information notification device according to an embodiment of the present disclosure includes a detection unit that detects occurrence of a failure in a controller to which telemetry information in a slice is notified, an identification unit that identifies telemetry requirements of the slice when the detection unit detects occurrence of the failure, and a determination unit that determines whether to notify an alternative controller of the telemetry information in the slice in accordance with the telemetry requirements identified by the identification unit.

### Advantageous Effects of Invention

According to one aspect of the embodiment, telemetry information can be relieved with a small number of resources.

### BRIEF DESCRIPTION OF DRAWINGS

FIG. 1 is a diagram showing an example of a telemetry information notification system according to an embodiment.

FIG. 2A is an explanatory diagram showing an outline of telemetry information notification processing according to the embodiment.

FIG. 2B is an explanatory diagram showing an outline of the telemetry information notification processing according to the embodiment.

FIG. 2C is an explanatory diagram showing an outline of the telemetry information notification processing according to the embodiment.

FIG. 2D is an explanatory diagram showing an outline of the telemetry information notification processing according to the embodiment.

FIG. 3 is a diagram showing a configuration example of a node according to the embodiment.

FIG. 4A is a diagram showing an example of the telemetry information notification processing according to the embodiment.

FIG. 4B is a diagram showing an example of the telemetry information notification processing according to the embodiment.

FIG. 5 is a diagram showing a configuration example of a controller according to the embodiment.

FIG. 6 is a sequence diagram showing an example of processing for changing a notification destination of the telemetry information executed by the telemetry information notification system according to the embodiment.

FIG. 7 is a flowchart showing an example of a processing for improving efficiency of a telemetry information notification executed by the node according to the embodiment.

FIG. 8 is a flowchart showing an example of a processing for improving efficiency of the telemetry information notification executed by the controller according to the embodiment.

FIG. 9 is a diagram showing an example of a hardware configuration.

### DESCRIPTION OF EMBODIMENTS

Hereinafter, an embodiment of the present disclosure will be described in detail with reference to the drawings. Note that this embodiment is not intended to limit the scope of the present invention. Details of one or more embodiments are described in the following description and drawings. Further, the plurality of embodiments can be appropriately combined within a range in which the processing contents are not contradictory to each other. In the following one or more embodiments, the same parts are denoted by the same reference signs, and redundant description is omitted.

### [1. Introduction]

In a network, information called telemetry information is collected by a network manager such as a communication provider. The telemetry information is various data related to a use state of communication. Examples of the telemetry information include a band, a delay amount, charging information, and the like.

Such telemetry information is transmitted from a node in the network to a controller in the network. The node is a switch for transferring packets. The controller is a computer for managing nodes. Therefore, the controller is a notification destination of the telemetry information from the node.

Techniques for handling failures in controllers have been proposed in terms of telemetry information notification. The failure handling technique is used to relieve the telemetry information when a failure occurs in the controller.

As an example of the failure handling technique, when a failure occurs in a controller, a node under the control of the controller can relieve telemetry information by directing telemetry information to another controller.

However, when the node directs the telemetry information to another controller, the processing addition of another controller increases. As a result, another controller may fail to take telemetry information.

If a network manager allocates a spare resource to another controller in preparation for the occurrence of a failure in the controller, another controller can relieve all telemetry information. However, spare resources lead to wasteful costs at normal times.

Therefore, a node according to an embodiment performs the telemetry information notification processing described below with in order to relieve the telemetry information with a minimum number of resources, when a failure occurs in a controller.

### [2. Configuration of Telemetry Information Notification System]

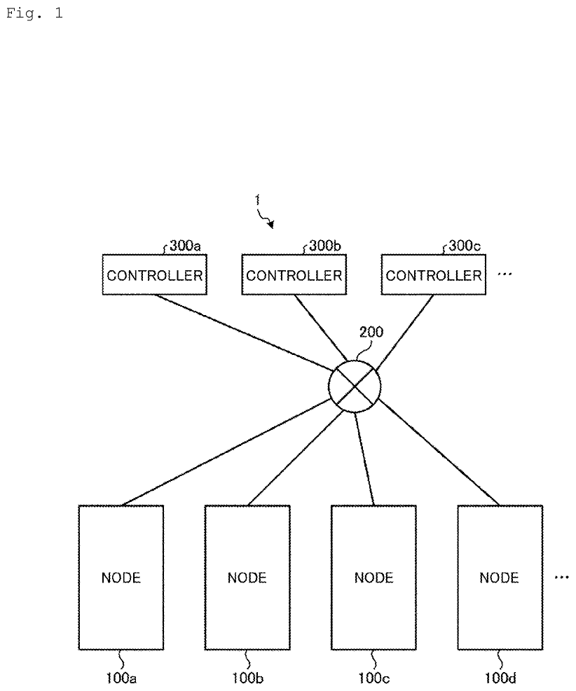

First, a telemetry information notification system according to the embodiment will be described with reference to FIG. 1.

FIG. 1 is a diagram showing an example of a configuration of the telemetry information notification system 1 according to the embodiment. As shown in FIG. 1, the telemetry information notification system 1 includes a node 100a, a node 100b, a node 100c, a node 100d, a network 200, a controller 300a, a controller 300b and a controller 300c.

In the present specification, when it is not necessary to distinguish the nodes 100a to 100d, the nodes 100a to 100d are collectively referred to as the node 100. In addition, when it is not necessary to distinguish the controllers 300a to 300c, the controllers 300a to 300c are collectively referred to as the controller 300.

In the telemetry information notification system 1, the node 100 and the controller 300 are connected to a network 200 by wire or wireless, respectively. The network 200 is, for example, a network such as the internet, a WAN (Wide Area Network), a LAN (Local Area Network). The telemetry information notification system 1 can communicate with each other via the network 200.

The node 100 is an information processing device for notifying the controller 300 of the telemetry information. The node 100 is an example of a telemetry information notification device. In order to relieve the telemetry information when the controller fails, the node 100 performs the telemetry information notification processing. The telemetry information notification processing is processing for improving efficiency of a telemetry information notification when the controller fails. The outline of the telemetry information notification processing is described in chapter 3.

The node 100 may be any type of information processing devices including a server. For example, when the node 100 operates as a virtual switch, the node 100 is implemented by software for a server. When the node 100 operates as a physical switch, the node 100 is implemented by a dedicated node device. A configuration example of the node 100 will be described in detail in chapter 4.

The controller 300 is an information processing device for collecting the telemetry information from the node 100. The controller 300 may be any type of information processing devices including a server. For example, the controller 300 is implemented by software for a server. A configuration example of the controller 300 will be described in detail in chapter 5.

### [3. Outline of Telemetry Information Notification Processing]

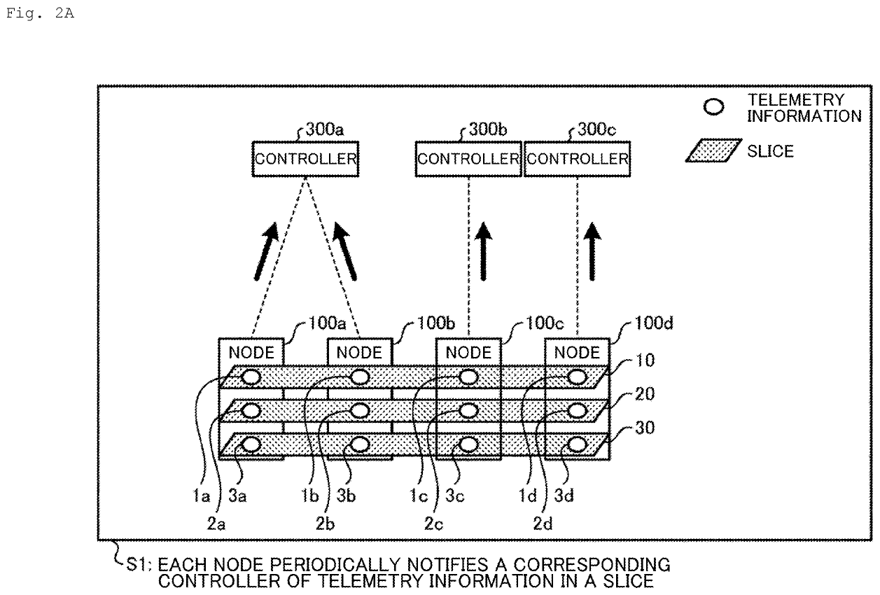

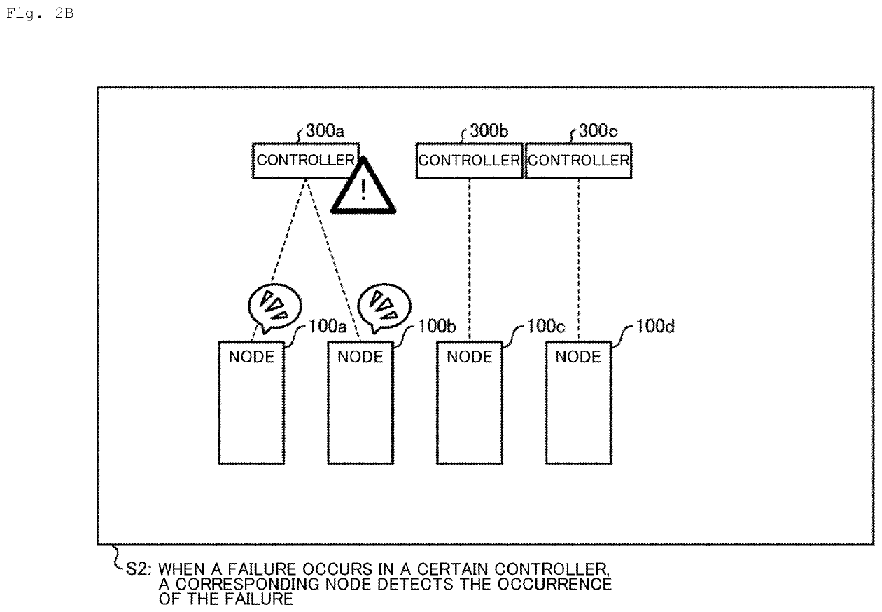

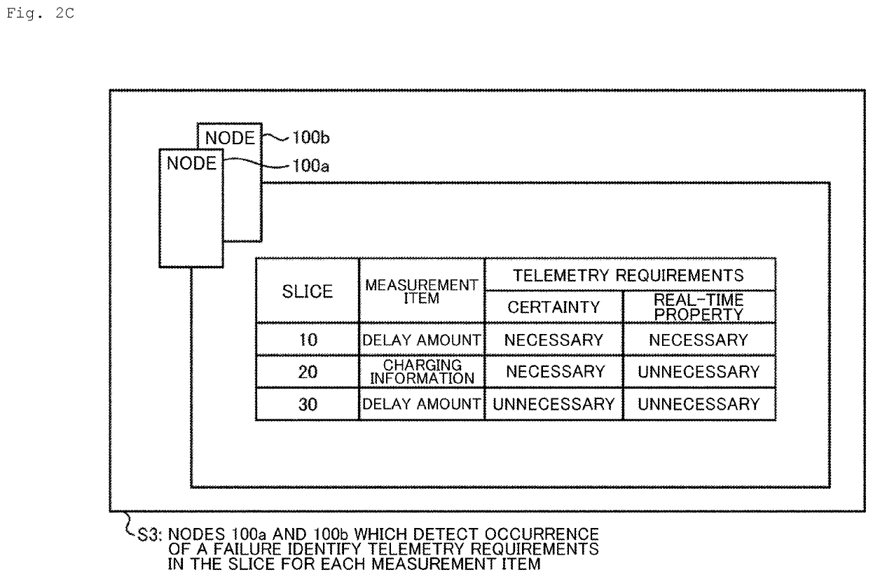

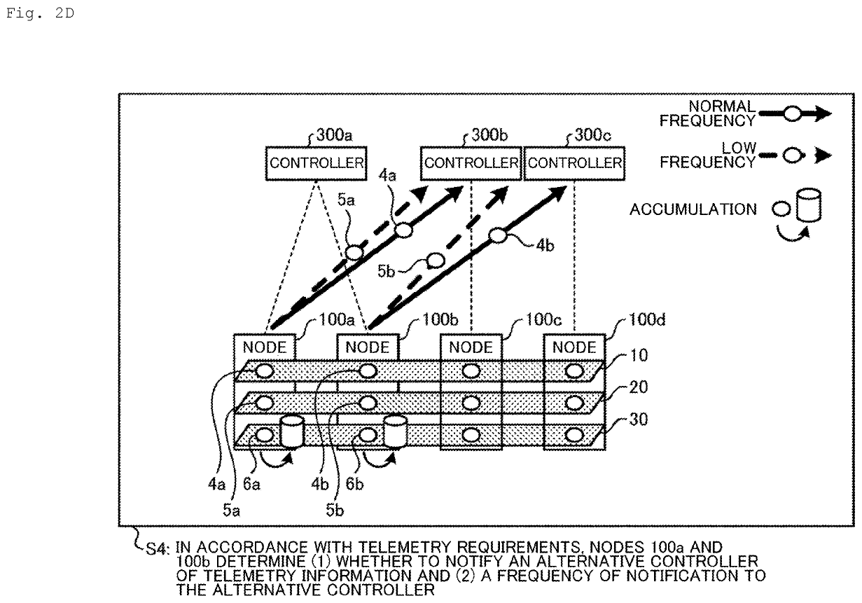

Next, the outline of telemetry information notification processing will be described with reference to FIGS. 2A, 2B, 2C and 2D. Note that this outline is not intended to limit the embodiments described in the following chapters.

FIGS. 2A, 2B, 2C and 2D are diagrams showing the outline of the telemetry information notification processing according to the embodiment.

In the examples of FIGS. 2A, 2B, 2C and 2D, the network manager provides services utilizing slices. The slice is also called a network slice. The slice is a virtual network constructed for each of various network services.

Referring to FIG. 2A, each node periodically notifies the corresponding controller of the telemetry information in the slice (step S1).

A node 100a notifies a controller 300a of telemetry information 1a in a slice 10, telemetry information 2a in a slice 20, and telemetry information 3a in a slice 30.

A node 100b notifies the controller 300a of telemetry information 1b in the slice 10, telemetry information 2b in the slice 20, and telemetry information 3b in the slice 30.

A node 100c notifies a controller 300b of telemetry information 1c in the slice 10, telemetry information 2c in the slice 20, and telemetry information 3c in the slice 30.

A node 100d notifies a controller 300c of telemetry information 1d in the slice 10, telemetry information 2d in the slice 20, and telemetry information 3d in the slice 30.

Referring to FIG. 2B, when a failure occurs in a certain controller, a corresponding node detects the occurrence of the failure (step S2).

In the example of FIG. 2B, it is assumed that a failure occurred in the controller 300a. In this example, the nodes 100a and 100b detect the occurrence of a failure by using ping, for example.

Referring to FIG. 2C, after the step S2 of FIG. 2B, the nodes 100a and 100b which detect the occurrence of the failure identify telemetry requirements for each measurement item of the slice (step S3).

The measurement items of the slices 10, 20, and 30 are a delay amount, charging information, and a delay amount. As shown in FIG. 2C, the telemetry requirements of the slice 10 require both certainty and real-time property. The telemetry requirements of the slice 20 require the certainty, but do not require the real-time property. The telemetry requirements of the slice 30 do not require both the certainty and the real-time property.

Referring to FIG. 2D, after the step S3 of FIG. 2C, the nodes 100a and 100b determine (1) whether to notify an alternative controller of the telemetry information, and (2) a frequency of the notification to the alternative controller in accordance with the telemetry requirement (step S4).

As described above, the telemetry requirements for the slice 10 require both the certainty and the real-time property. Therefore, the node 100a notifies the controller 300b of the telemetry information 4a in the slice 10 at a normal frequency. In this case, the controller 300b is the alternative controller of the controller 300a. Similarly, the node 100b notifies the controller 300c of the telemetry information 4a in the slice 10 at the normal frequency. The controller 300c is the alternative controller of the controller 300a.

The telemetry requirements of the slice 20 require the certainty, but do not require the real-time property. Therefore, the node 100a notifies the controller 300b of the telemetry information 5a in the slice 20 at a low frequency. For example, the node 100a stores the telemetry information 5a in a storage device of the node 100a for a fixed period. After a lapse of the fixed period, the node 100a notifies the controller 300b of the telemetry information 5a. Similarly, the node 100b notifies the controller 300b of the telemetry information 5b in the slice 20 at the low frequency.

The telemetry requirements of the slice 30 do not require both the certainty and the real-time property. Therefore, the node 100a temporarily stores the telemetry information 6a in the slice 30 in the storage device of the node 100a. When the failure is recovered, the node 100a notifies the controller 300a of the stored telemetry information 6a. Similarly, the node 100b temporarily stores the telemetry information 6b in the slice 30 in the storage device of the node 100b.

As described above, when a failure occurs in the controller 300a, the nodes 100a and 100b identify the telemetry requirements of the slice. Then, the nodes 100a and 100b handle the failure in accordance with the telemetry requirements.

Specifically, the nodes 100a and 100b immediately notify the alternative controller of the telemetry information requiring the certainty and the real-time property. Also, the nodes 100a and 100b notify the alternative controller of the telemetry information requiring the certainty but not requiring the real-time property at the low frequency. On the other hand, the nodes 100a and 100b store the telemetry information not requiring both the certainty and the real-time property in the storage device. After the controller 300a is restored, the nodes 100a and 100b notify the controller 300a of the stored telemetry information.

Thus, the nodes 100a and 100b can reduce spare resources allocated to the controllers 300b and 300c in preparation for the occurrence of a failure in the controller 300a. Also, even when a large number of resources for the alternative controller is not prepared for the occurrence of a failure, the nodes 100a and 100b can relieve the important telemetry information with the minimum number of resources.

### [4. Configuration of Node]

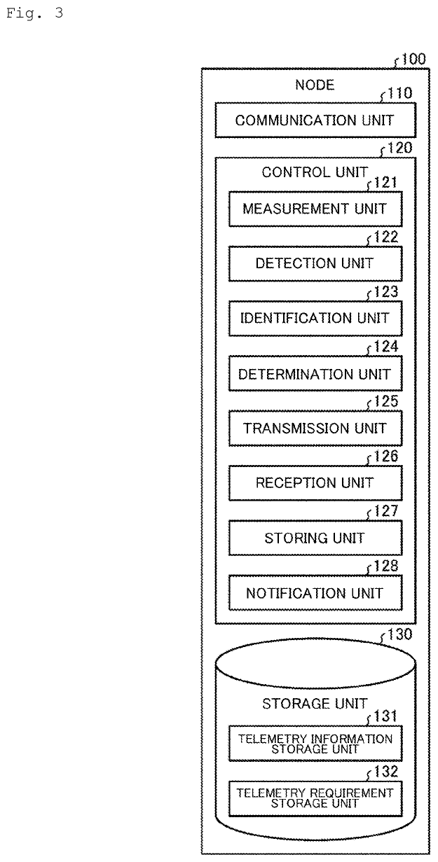

Next, the configuration of the node 100 will be described with reference to FIG. 3.

FIG. 3 is a diagram showing a configuration example of the node 100 according to the embodiment. As shown in FIG. 3, the node 100 includes a communication unit 110, a control unit 120, and a storage unit 130. The node 100 may also have an input unit (e.g., keyboard, mouse, etc.) for receiving various operations from a manger or other person using the node 100, and a display unit (organic EL (Electro Luminescence), liquid crystal display, etc.) for displaying various types of information.

### (Communication Unit 110)

The communication unit 110 is realized by, for example, an NIC (Network Interface Card) and the like. The communication unit 110 is connected to the network 200 by wire or wireless. The communication unit 110 may be communicably connected to the controller 300 via the network 200. The communication unit 110 can transmit and receive information via the network 200.

### (Control Unit 120)

The control unit 120 is a controller. The control unit 120 is realized by a processor such as a CPU (Central Processing Unit) or MPU (Micro Processing Unit) executing various programs (corresponding to an example of a telemetry information notification program) stored in the storage device inside the node 100 by using a RAM (Random Access Memory) and the like as a working area. Further, the control unit 120 may be realized by integrated circuits, for example, an ASIC (Application Specific Integrated Circuit), a FPGA (Field Programmable Gate Array), GPGPU (General Purpose Graphic Processing Unit).

As shown in FIG. 3, the control unit 120 includes a measurement unit 121, a detection unit 122, an identification unit 123, a determination unit 124, a transmission unit 125, a reception unit 126, a storing unit 127 and a notification unit 128, and the functions and operations of the information processing described below are realized or executed. One or more processors of the node 100 can realize functions of each control unit in the control unit 120 by executing instructions stored in one or a plurality of memories of the node 100. Note that an internal configuration of the control unit 120 is not limited to the configuration shown in FIG. 3, but the internal configuration of the control unit 120 may be other configurations as long as it performs information processing to be described later. For example, the determination unit 124 may perform all or part of information processing to be described later on parts other than the determination unit 124.

### (Measurement Unit 121)

The measurement unit 121 measures the telemetry information in the slice. For example, the measurement unit 121 measures the telemetry information such as an operation state of the node and communication quality. The measurement unit 121 stores the telemetry information in a telemetry information storage unit 131 described later.

### (Detection Unit 122)

The detection unit 122 detects a failure of the controller 300. Also, the detection unit 122 detects restoration of the controller 300.

### <Identification Unit 123>

The identification unit 123 identifies the telemetry requirements of the slice when the detection unit 122 detects occurrence of a failure. For example, the identification unit 123 identifies the telemetry requirements stored in the telemetry requirement storage unit 132 described later.

### (Determination Unit 124)

A determination unit 124 determines whether to notify the alternative controller of telemetry information in the slice according to the telemetry requirements identified by the identification unit 123. A determination unit 124 controls a method of notifying the telemetry information. For example, the determination unit 124 determines a notification destination of the telemetry information or a notification frequency of the telemetry information notification on the basis of a situation of the failure of the controller 300 and the telemetry requirements.

As an example, when the telemetry requirements request both the certainty and the real-time property, the determination unit 124 determines to notify the alternative controller of the telemetry information. When the telemetry requirements request the certainty but does not request the real-time property, the determination unit 124 determines to notify the alternative controller of the telemetry information at a frequency lower than a notification frequency when a failure does not occur in the controller 300. When the telemetry requirements do not request both of the certainty and the real-time property, the determination unit 124 determines to store the telemetry information in the telemetry information storage unit 131 described later.

### (Transmission Unit 125)

The transmission unit 125 transmits various types of information to the controller 300. when the determination unit 124 determines to notify the alternative controller of the telemetry information, the transmission unit transmits the telemetry information and the telemetry requirements to another controller which is a candidate of the alternative controller. For example, when the detection unit 122 detects a failure of the controller 300a, another controller, for example, is at least one of the controllers 300b and 300c shown in FIG. 1. A list indicating candidates for the alternative controller may be stored in the telemetry information storage unit 131 described later. The transmission unit 125 may specify a candidate of the alternative controller on the basis of the list.

### (Reception Unit 126)

The reception unit 126 receives various instructions from the controller. The reception unit 126 receives a notification indicating whether another controller can operate as the alternative controller. Another controller (for example, controllers 300b and 300c in FIG. 1) is a controller that have received the telemetry information and telemetry requirements transmitted by the transmission unit 125.

### (Storing Unit 127)

The storing unit 127 stores the telemetry information in the telemetry information storage unit 131 described later in accordance with the determination by the determination unit 124. In this case, the storing unit 127 may be mounted as a first storing unit. When the storing unit 127 stores the telemetry information in accordance with the determination of the notification unit 128 described later, the storing unit 127 may be mounted as a second storing unit.

### (Notification Unit 128)

The notification unit 128 notifies another controller of the telemetry information when the notification received by the reception unit 126 indicates that another controller can operate as the alternative controller. The notification unit 128 notifies another controller of the telemetry information in accordance with the telemetry requirements. For example, when the determination unit 124 determines that the telemetry requirements request both the certainty and the real-time property, the notification unit 128 notifies the alternative controller of the telemetry information. When the determination unit 124 determines that the telemetry requirements request the certainty but does not require the real-time property, the notification unit 128 notifies the alternative controller of the telemetry information at a frequency lower than a notification frequency when a failure does not occur in the controller 300.

### (Storage Unit 130)

The storage unit 130 is realized by using a semiconductor memory element such as a RAM or a flash memory, or a storage device such as a hard disk or an optical disk, for example. As shown in FIG. 3, the storage unit 130 includes the telemetry information storage unit 131 and the telemetry requirement storage unit 132.

### (Telemetry Information Storage Unit 131)

The telemetry information storage unit 131 stores the telemetry information measured by the measurement unit 121. The telemetry information storage unit 131 may store the list indicating candidates of the alternative controller.

### (Telemetry Requirement Storage Unit 132)

The telemetry requirement storage unit 132 stores the telemetry requirements of the slice. The telemetry requirements of the slice differ depending on the service.

As an example, the telemetry requirements of the SLA service request the certainty and the real-time property of the telemetry information. This is because the SLA service requests guarantee of the communication quality.

As another example, the telemetry requirements of the meter-rate charging service request the certainty of telemetry information. This is because the information related to the charging must be surely notified. However, since the real-time property is not required so much, the telemetry requirements of the meter-rate charging service do not require the real-time property.

As yet another example, the telemetry requirements of the flat-rate best-effort service do not require both the certainty and the real-time property of the telemetry information. This is because, even if the certainty and the real-time property are low, this has little influence on the service.

### Example of Telemetry Information Notification Processing

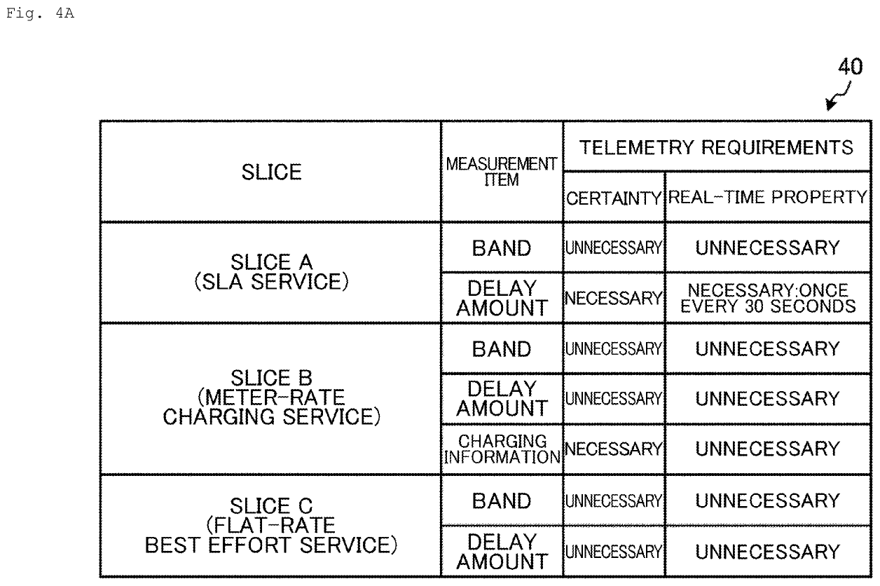

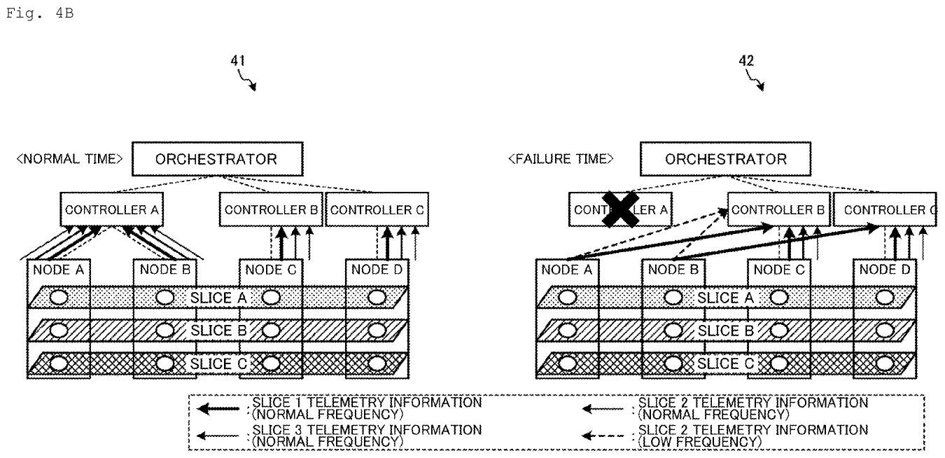

In the above description, the outline of the telemetry information notification processing has been described with reference to FIGS. 2A, 2B, 2C and 2D. Here, an example of the telemetry information notification processing will be described in more detail with reference to FIGS. 4A and 4B.

FIGS. 4A and 4B are explanatory diagrams showing an example of the telemetry information notification processing according to the embodiment. FIG. 4A shows telemetry requirement 40, an example of telemetry requirements of services provided in slices. When the controller 300 fails, the corresponding node 100 identifies the slice. The node 100 identifies the service provided in the slice and the telemetry requirements of the service from the telemetry requirement 40. In response to the identified service and telemetry requirements, the node 100 changes a method for handling a failure for each measurement item of the slice and the telemetry information.

The following three methods can be considered as handling methods.

First method is a method of immediately switching a notification destination of telemetry information from a corresponding controller to another controller. The node continues target telemetry information notification at a frequency equivalent to the frequency before the failure. The first method corresponds to an SLA service that requests the certainty and the real-time property.

Second method is a method of accumulating the target telemetry information in the node and collectively notifying other controllers of the accumulated telemetry information. The node can reduce the number of times of telemetry information notification, thereby reducing processing addition of other controllers. The second method correspond to a meter-rate charging service that requests the certainty but does not require the real-time property.

Third method is a method of accumulating the target telemetry information in the node and notifying a corresponding controller of the target telemetry information at a timing when the corresponding controller recovers. In the third method, when the disk capacity is tight, the node erases the telemetry information in the older order. The third method corresponds to a flat-rate best-effort service that does not require any of certainty and real-time property of the telemetry information.

Even when the first telemetry information and the second telemetry information are telemetry information in the same slice, telemetry requirements of the first telemetry information and the second telemetry information may be different depending on measurement items. For example, the measurement items of slice A of FIG. 4A include a band and a delay amount. The band of slice A does not require both the certainty and the real-time property. On the other hand, the delay amount of slice A requests the certainty and the real-time property (once per 30 seconds).

The node changes a method of notifying the telemetry information according to each telemetry requirement. For example, when the measurement item guaranteed in the SLA service is only delay, the node, in the first method described above, handles the telemetry information of the delay amount. In this case, the node handles the telemetry information of the band by the third method described above.

As a technique for constructing the slice, it has been proposed to add a dedicated header called a slice identifier to a packet. If the slice is constructed using the slice identifier, the node may use the slice identifier to determine the telemetry requirements. For example, information that allows the node to determine telemetry requirements may be embedded in the slice identifier. The node may identify a method of notifying the telemetry information based on the information embedded in the slice identifier.

FIG. 4B shows a telemetry information notification 41 at a normal time and a telemetry information notification 42 at a failure time. For example of telemetry requirements, the delay amount of the slice A requests the certainty and the real-time property. The charging information of the slice B requires the certainty but does not requests the real-time property. The measurement items of the slice C do not require both the certainty and the real-time property.

In the telemetry information notification 41 in the normal time, the telemetry information of all slices is notified to a plurality of controllers storing respective nodes at a predetermined frequency.

In the telemetry information notification 42 at the failure time, a failure occurs in the controller A. In this case, the node A and the node B under the control of the controller A change the notification destination of the telemetry information as follows. Note that the information on the alternative controllers B and C may be set in advance in the nodes A and B. Alternatively, when a failure occurs in the controller A, another controller or another node may notify the nodes A and B of information about the alternative controller.

As for the delay amount of the slice A, the nodes A and B immediately switch the notification destination of the telemetry information from the controller A to the alternative controller B or the alternative controller C. Then, the nodes A and B notify of the telemetry information at a frequency equivalent to the frequency before the failure.

As for the charging information of the slice B, the nodes A and B accumulate the telemetry information in the nodes A and B. Then, the nodes A and B collectively notify the alternative controller B or the alternative controller C of the accumulated telemetry information at a low frequency.

As for the information of the slice C, the nodes A and B accumulate the telemetry information in the nodes A and B. After the controller A is recovered, the nodes A and B notify the controller A of the accumulated telemetry information. When the nodes A and B cannot accumulate the telemetry information, the nodes A and B erase the telemetry information in the older order.

### [5. Configuration of Controller]

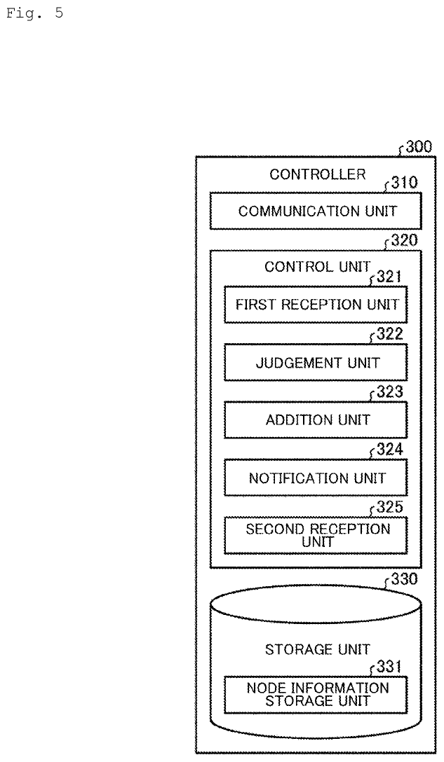

Next, the configuration of the controller 300 will be described with reference to FIG. 5.

FIG. 5 is a diagram showing a configuration of the controller 300 according to the embodiment. As shown in FIG. 5, the controller 300 includes a communication unit 310, a control unit 320, and a storage unit 330. The controller 300 may also have an input unit (e.g., keyboard, mouse, etc.) for receiving various operations from a manager or other person using the controller 300, and a display unit (organic EL (Electro Luminescence), liquid crystal display, etc.) for displaying various types of information.

### (Communication Unit 310)

The communication unit 310 is realized by, for example, an NIC. The communication unit 310 is connected to the network 200 by wire or wireless. The communication unit 310 may be communicably connected to the node 100 via the network 200. The communication unit 310 can transmit and receive information via the network 200.

### (Control Unit 320)

The control unit 320 is a controller. The control unit 320 uses, for example, a RAM or the like as a working area, and is realized by a processor such as a CPU or an MPU which executes various programs stored in a storage device inside the controller 300. Further, the control unit 320 is realized by an integrated circuit such as an ASIC, an FPGA and a GPGPU.

As shown in FIG. 5, the control unit 320 includes a first reception unit 321, a judgement unit 322, an addition unit 323, a notification unit 324 and a second reception unit 325, and realizes and executes the functions and operations of the information processing described below. One or a plurality of processors of the controller 300 can realize functions of each control unit in the control unit 320 by executing instructions stored in one or a plurality of memories of the controller 300. Note that an internal configuration of the control unit 320 is not limited to the configuration shown in FIG. 5, but the internal configuration of the control unit 320 may be other configurations as long as it performs information processing described later. For example, the judgement unit 322 may perform all or part of information processing described later on parts other than the judgement unit 322.

### (First Reception Unit 321)

The first reception unit 321 receives various information from the node 100. When a failure occurs in another controller, the first reception unit 321 receives the telemetry information and the telemetry requirements.

### (Judgement Unit 322)

When the first reception unit 321 receives the telemetry information and the telemetry requirements, the judgement unit 322 judges whether the controller operates as an alternative controller of another controller.

### (Addition Unit 323)

The addition unit 323 manages information on a notification source of the telemetry information. When the judgement unit 322 judges that the controller operates as an alternative controller of another controller, the addition unit 323 adds information for identifying the node 100 to a node information storage unit 331 described later as node information.

### (Notification Unit 324)

When the addition unit 323 adds information for identifying the node 100, the notification unit 324 notifies the node 100 that the controller operates as an alternative controller of another controller. When the judgement unit 322 judges that the controller does not operate as an alternative controller of another controller, the notification unit 324 may instruct the node 100 to further search for another alternative controller.

### (Second Reception Unit 325)

When the notification unit 324 notifies the node 100 that the controller operates as an alternative controller of another controller, the second reception unit 325 periodically receives the telemetry information from the node 100.

### (Storage Unit 330)

The storage unit 330 is realized using a semiconductor memory element such as a RAM or a flash memory, or a storage device such as a hard disk or an optical disk. As shown in FIG. 5, the storage unit 330 includes a node information storage unit 331.

### (Node Information Storage Unit 331)

The node information storage unit 331 stores the node information added by the addition unit 323. As described above, the node information is information for identifying the node 100 which is a notification source of the telemetry information.

[6. Sequence Diagram of Notification Destination change Processing]

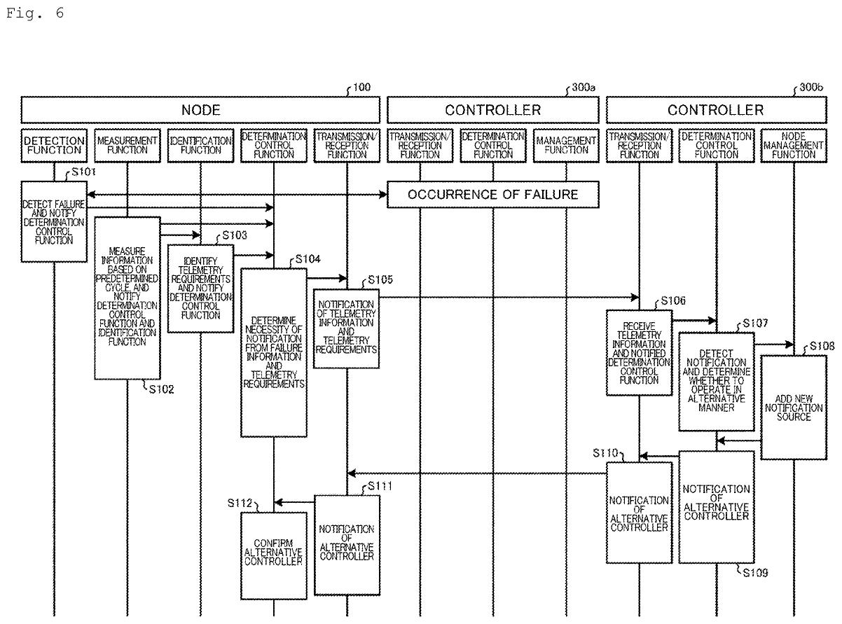

Next, a sequence diagram of an example of notification destination change processing will be described with reference to FIG. 6. The notification destination change processing is processing for changing a notification destination of the telemetry information.

FIG. 6 is a sequence diagram showing an example of processing for changing the notification destination of the telemetry information executed by the telemetry information notification system 1 according to the embodiment.

As shown in FIG. 6, first, the detection function of the node 100 detects a failure of the controller 300a and notifies a determination control function (step S101). The detection function and the determination control function are implemented by the detection unit 122 and the determination unit 124, respectively.

Then, the measurement function of the node 100 measures information on the basis of a predetermined cycle, and notifies the determination control function and the identification function (step S102). The information to be measured is, for example, telemetry information. The predetermined cycle is a cycle in normal operation. The measurement function and the identification function are implemented by the measurement unit 121 and the identification unit 123, respectively.

Then, the identification function of the node 100 identifies the telemetry requirements and notifies the determination control function (step S103).

Then, the determination control function of the node 100 determines whether or not notification is necessary from the failure information and the telemetry requirements (step S104). In the example shown in FIG. 6, the determination control function determines to notify the controller 300b.

Then, the transmission/reception function of the node 100 notifies the controller 300b of the telemetry information and the telemetry requirements (step S105). The transmission/reception function is implemented by the transmission unit 125 and the reception unit 126.

Then, the transmission/reception function of the controller 300b receives the telemetry information and notifies the determination control function (step S106). The transmission/reception function and the determination control function are implemented by the first reception unit 321 and the judgement unit 322, respectively.

Then, the determination control function of the controller 300b detects the notification from the node 100 under the control of the controller 300a, and determines whether the controller 300b operates in an alternative manner (step S107). In the example shown in FIG. 6, the determination control function determines that the controller 300b operates in an alternative manner.

Then, the node management function of the controller 300b adds a new notification source (step S108). In the example of FIG. 6, the node 100 is newly added as a node for notifying the controller 300b of the telemetry information.

Then, the determination control function of the controller 300b notifies the transmission/reception function of the controller 300b of information on the alternative controller (step S109). The information on the alternative controller indicates that the controller 300b becomes an alternative controller of the node 100.

Then, the transmission/reception function of the controller 300b notifies the transmission/reception function of the node 100 of information on the alternative controller (step S110).

Then, the transmission/reception function of the node 100 notifies the determination control function of the node 100 of information on the alternative controller (step S111).

Then, the determination control function of the node 100 confirms the alternative controller (step S112). That is, the determination control function confirms that the controller 300b becomes an alternative controller of the node 100.

Thereafter, the node 100 transmits the telemetry information to the controller 300b which becomes the alternative controller.

### [7. Flowchart of Telemetry Information Notification Processing]

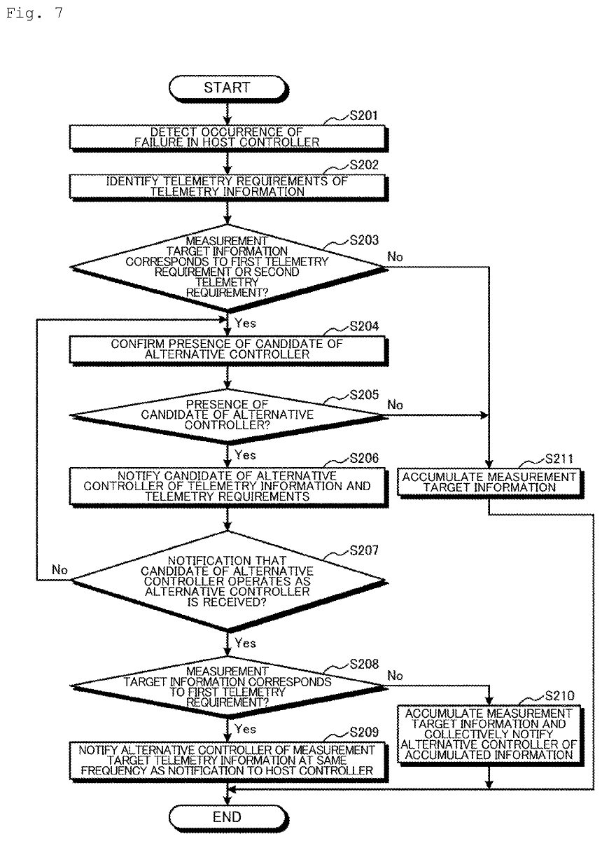

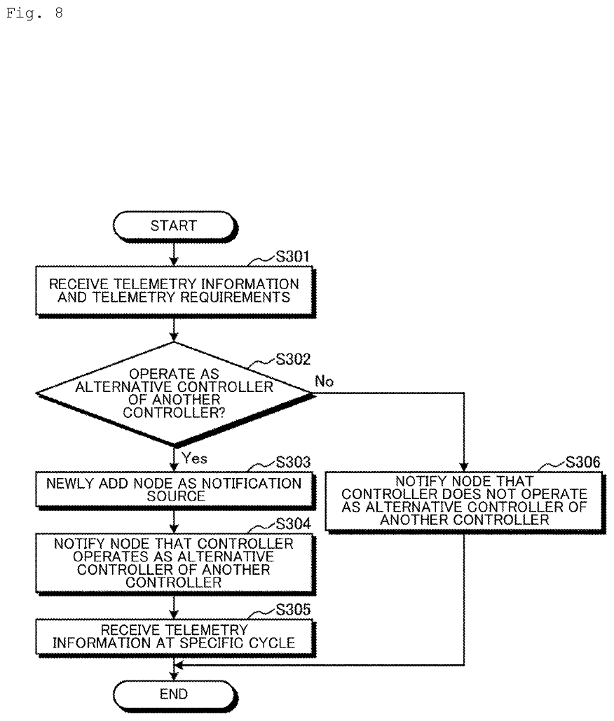

Next, a flow chart of an example of telemetry information notification processing will be described with reference to FIGS. 7 and 8. One example of telemetry information notification processing includes processing for improving efficiency of the telemetry information notification.

FIG. 7 is a flowchart showing an example of a processing for improving efficiency the telemetry information notification that is executed by the 100 according to the embodiment.

As shown in FIG. 7, first, the detection unit 122 of the node 100 detects occurrence of a failure in the host controller (step S201). The host controller is a controller for accommodating the node 100. The host controller is, for example, the controller 300a.

Then, the identification unit 123 of the node 100 identifies the telemetry requirements of the telemetry information in the slice measured by the node 100 (step S202).

Then, the determination unit 124 of the node 100 judges whether the measurement target information corresponds to the first telemetry requirement or the second telemetry requirement (step S203).

When it is judges that the measurement target information corresponds to the first telemetry requirement or the second telemetry requirement in the step S203 (step S203: Yes), the transmission unit 125 of the node 100 confirms whether there is a candidate of an alternative controller (step S204). For example, the transmission unit 125 confirms the list indicating the candidates of the alternative controller stored in the telemetry information storage unit 131. The alternative controller is, for example, the controller 300b or the controller 300c.

In the example of FIG. 7, the first telemetry requirement requests the certainty and the real-time property. The second telemetry requirement requests the certainty but does not require the real-time property.

Then, the transmission unit 125 judges whether there is a candidate of the alternative controller (step S205).

When it is judged in the step S205 that there is a candidate of the alternative controller (step S205: Yes), the transmission unit 125 of the node 100 notifies the candidate of the alternative controller of the telemetry information and the telemetry requirements (step S206). For example, the transmission unit 125 selects one candidate from a plurality of candidates of the alternative controller, and notifies the selected candidate of the telemetry information and the telemetry requirements.

Then, the reception unit 126 of the node 100 judges whether a notification that the candidate of the alternative controller can operate as the alternative controller is received (step S207).

When the notification that the candidate of the alternative controller can operate as the alternative controller is received in the step S207 (step S207: Yes), the notification unit 128 of the node 100 judges whether the measurement target information corresponds to the first telemetry requirement (step S208).

In the step S207, when the notification that the candidate of the alternative controller cannot operate as the alternative controller is received (step S207: No), the transmission unit 125 executes the step S204 again.

When it is judged in the step S208 that the measurement target information corresponds to the first telemetry requirement (step S208: Yes), the notification unit 128 notifies the alternative controller of the telemetry information of the measurement target at the same frequency as the notification to the host controller (step S209).

When it is judged in the step S208 that the measurement target information does not correspond to the first telemetry requirement (step S208: No), the notification unit 128 accumulates the measurement target information, and collectively notifies the alternative controller of the accumulated information (step S210).

When it is judged in the step S203 that the measurement target information does not correspond to the first telemetry requirement and the second telemetry requirement (step S203: No), the storing unit 127 (for example, a first storing unit) of the node 100 stores the measurement target information (step S211). In this case, the measurement target information corresponds to telemetry requirements that do not require both the certainty and the real-time property.

When it is judged in the step S205 that there is no candidate of the alternative controller (step S205: No), the processing step proceeds step S211. In this case, the storing unit 127 (for example, the second storing unit) of the node 100 accumulates the measurement target information.

FIG. 8 is a flowchart showing an example of processing for improving efficiency of telemetry information notification that is executed by the controller 300 according to the embodiment.

As shown in FIG. 8, first, the first reception unit 321 of the controller 300 receives the telemetry information and the telemetry requirements from the node 100 (step S301).

Then, the judgement unit 322 of the controller 300 judges whether the controller operates as an alternative controller of another controller (step S302).

In the step S302, when the judgement unit 322 judges that the controller operates as an alternative controller of another controller (step S302: Yes), the addition unit 323 newly adds a node as a notification source (step S303).

Then, the notification unit 324 of the controller 300 notifies the node 100 that the controller operates as an alternative controller of another controller (step S304).

Then, the second reception unit 325 of the controller 300 receives the telemetry information from the node 100 at a specific cycle (step S305).

In the step S302, when the judgement unit 322 judges that the controller does not operate as an alternative controller of another controller (step S302: No), the notification unit 324 notifies the node 100 that the controller does not operate as an alternative controller of another controller (step S306).

### [8. Effects]

As described above, the node 100 according to the embodiment includes the detection unit 122, the identification unit 123 and the determination unit 124.

In the node 100 according to the embodiment, the detection unit 122 detects occurrence of a failure in the controller to which telemetry information in the slice is notified. In addition, in the node 100 according to the embodiment, the identification unit 123 identifies the telemetry requirements of the slice when the detection unit 122 detects occurrence of the failure. Further, in the node 100 according to the embodiment, the determination unit 124 determines whether to notify the alternative controller of the telemetry information in the slice in accordance with the telemetry requirements identified by the identification unit 123. For example, the determination unit 124 determines whether to notify the alternative controller of the telemetry information and a method of the notification in accordance with the telemetry requirements.

In addition, in the node 100 according to the embodiment, the determination unit 124 judges whether the telemetry requirements request the certainty and the real-time property, and when the telemetry requirements request both the certainty and the real-time property, it is determined to notify the alternative controller of the telemetry information in the slice.

Also, in the node 100 according to the embodiment, the determination unit 124 judges whether the telemetry requirements request the certainty and the real-time property, and when the telemetry requirements request the certainty but do not quest the real-time property, it is determined to notify the alternative controller of the telemetry information in the slice at a frequency lower than a notification frequency when a failure does not occur in the controller.

In addition, the node 100 according to the embodiment includes the transmission unit 125 that the transmits telemetry information and the telemetry requirements in the slice to another controller that is a candidate of the alternative controller when the determination unit 124 determines to notify the alternative controller of the telemetry information in the slice. Also, the node 100 according to the embodiment includes the reception unit 126 for receiving the notification indicating whether another controller can operate as an alternative controller. Further, the node 100 according to the embodiment includes the notification unit 128 for notifying another controller of the telemetry information in the slice when the notification received by the reception unit 126 indicates that another controller can operate as an alternative controller.

In addition, in the node 100 according to the embodiment, the determination unit 124 judges whether the telemetry requirements request the certainty and the real-time property, and when the telemetry requirements do not request both the certainty and the real-time property, it is determined that the telemetry information in the slice is stored in a predetermined storage device.

By the above-described processing, the node 100 can notify of the telemetry information in such a manner that the telemetry information can be relieved even by the alternative controller with the small number of resources.

### [9. Others]

Also, out of the pieces of processing that have been described in the embodiment, some pieces of processing that have been described as being executed automatically may also be executed manually. Alternatively, all or part of pieces of processing described as being manually performed can be automatically performed by known methods. In addition, information including the processing procedure, specific name, various data and parameters that are shown in the above documents and figures may be arbitrarily changed unless otherwise described. For example, the various information shown in each figure is not limited to the information shown in the figure.

In addition, the components of each of the devices shown in the figures are shown as functional concept and do not necessarily need to be configured physically as shown in the figures. In other words, the specific aspects of distribution and integration of the devices are not limited to those shown in the figures, all or part of the components may be distributed or integrated functionally or physically in desired units depending on various types of loads and states of use.

For example, a part or all of the storage unit 130 shown in FIG. 3 may be held in a storage server or the like instead of being held by the node 100. In this case, the node 100 acquires various information such as telemetry requirements by accessing the storage server.

### [10. Hardware Configuration]

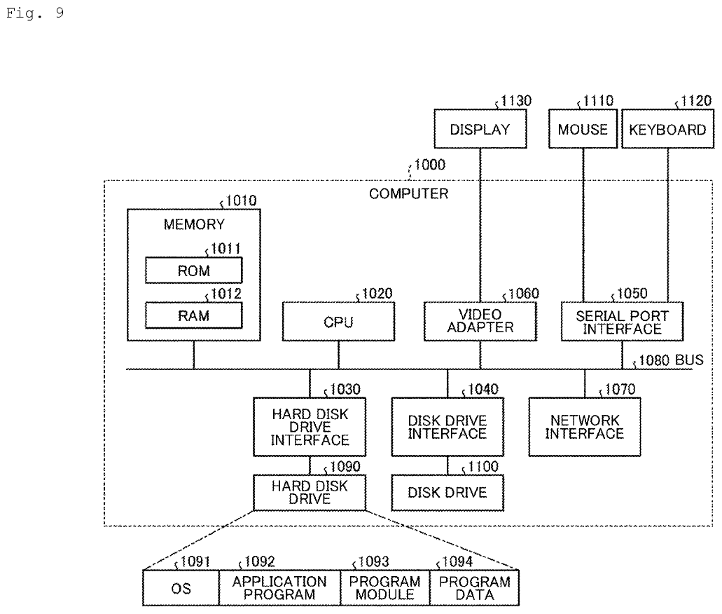

FIG. 9 is a diagram showing an example of a hardware configuration. The node 100 and the controller 300 according to the above-described embodiment is realized by, for example, a computer 1000 having a configuration as shown in FIG. 9.

FIG. 9 is a diagram showing an example of a computer in which the node 100 and the controller 300 are realized by executing a program. The computer 1000 includes, e.g., a memory 1010 and a CPU 1020. In addition, the computer 1000 includes a hard disk drive interface 1030, a disk drive interface 1040, a serial port interface 1050, a video adapter 1060, and a network interface 1070. Each of these units is connected by a bus 1080.

The memory 1010 includes a ROM (Read Only Memory) 1011 and a RAM 1012. The ROM 1011 stores, for example, a boot program such as a Basic Input Output System (BIOS). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, a program defining each processing of the node 100 and the controller 300 is implemented as the program module 1093 in which a code that can be executed by the computer 1000 is described. The program module 1093 is stored in, for example, the hard disk drive 1090. For example, the program module 1093 for executing the same processing as a functional configuration in the node 100 and the controller 300 is stored in the hard disk drive 1090. The hard disk drive 1090 may be replaced with a solid state drive (SSD).

Furthermore, the setting data used in the processing of the above-described embodiment is stored, for example, in the memory 1010 or the hard disk drive 1090 as the program data 1094. Then, the CPU 1020 reads the program module 1093 and the program data 1094 stored in the memory 1010 or the hard disk drive 1090 into the RAM 1012 and executes them as necessary.

Note that the program module 1093 and program data 1094 are not limited to being stored in the hard disk drive 1090, and may also be stored in, for example, a removable storage medium and read out by the CPU 1020 via the disk drive 1100, etc. Alternatively, the program module 1093 and program data 1094 may be stored in other computers connected via a network (LAN, WAN or the like). Then, the program module 1093 and program data 1094 may be read out from the other computers via the network interface 1070 by the CPU 1020.

While some of the embodiments of the present application have been described in detail with reference to the drawings, these are exemplified and the present invention is not limited to specific examples. The features described herein can be implemented in various modifications, improvements based on the knowledge of those skilled in the art, including aspects described in the column of aspects for implementing the invention.

Further, the above-mentioned “unit” can be read by module, section, methods, circuit and the like. For example, the determination unit can be replaced by a determination module or a determination circuit.

### REFERENCE SIGNS LIST

1 Telemetry information notification system
100 Node
110 Communication unit
120 Control unit
121 Measurement unit
122 Detection unit
123 Identification unit
124 Determination unit
125 Transmission unit
126 Reception unit
127 Storing unit
128 Notification unit
130 Storage unit
131 Telemetry information storage unit
132 Telemetry requirement storage unit
200 Network
300 Controller
310 Communication unit
320 Control unit
321 First reception unit
322 Judgement unit
323 Addition unit
324 Notification unit
325 Second reception unit
330 Storage unit
331 Node information storage unit

1. A telemetry information notification device comprising:
a detection unit, including one or more processors, configured to detect occurrence of a failure in a controller to which telemetry information in a slice is notified;
an identification unit, including one or more processors, configured to identify telemetry requirements of the slice when the detection unit detects the occurrence of the failure; and
a determination unit, including one or more processors, configured to determine whether to notify an alternative controller of the telemetry information in the slice in accordance with the telemetry requirements identified by the identification unit.

2. The telemetry information notification device according to claim 1 wherein
the determination unit is configured to judge whether the telemetry requirements request certainty and real-time property, and determine to notify the alternative controller of the telemetry information in the slice when the telemetry requirements request both the certainty and the real-time property.

3. The telemetry information notification device according to claim wherein
the determination unit is configured to judge whether the telemetry requirements request the certainty and the real-time property, and determine to notify the alternative controller of the telemetry information in the slice at a frequency lower than a notification frequency when a failure does not occur in the controller when the telemetry requirements request the certainty but do not request the real-time property.

4. The telemetry information notification device according to claim 2, further comprising:
a transmission unit, including one or more processors, configured to transmit the telemetry information and the telemetry requirements in the slice to another controller that is a candidate of the alternative controller when the determination unit determines to notify the alternative controller of the telemetry information in the slice;
a reception unit, including one or more processors, configured to receive a notification indicating whether the other controller can operate as the alternative controller; and
a notification unit, including one or more processors, configured to notify the other controller of the telemetry information in the slice when the notification received by the reception unit indicates that the other controller can operate as the alternative controller.

5. The telemetry information notification device according to claim 1, wherein
the determination unit is configured to judge whether the telemetry requirements request the certainty and the real-time property, and determine to store the telemetry information in the slice in a predetermined storage device when the telemetry requirements do not request both the certainty and the real-time property.

6. A telemetry information notification method executed by a computer, the telemetry information notification method comprising:
a detection step of detecting occurrence of a failure in a controller to which telemetry information in a slice is notified;
an identification step of identifying telemetry requirements of the slice when the detection step detects the occurrence of the failure; and
a determination step of determining whether to notify an alternative controller of the telemetry information in the slice in accordance with the telemetry requirements identified by the identification step.

7. A non-transitory computer-readable storage medium storing a telemetry information notification program causing a computer to execute operations comprising:
a detection procedure for detecting occurrence of a failure in a controller to which telemetry information in a slice is notified;
an identification procedure for identifying telemetry requirements of the slice when the detection procedure detects the occurrence of the failure; and
a determination procedure for determining whether to notify an alternative controller of the telemetry information in the slice in accordance with the telemetry requirements identified by the identification procedure.

8. The telemetry information notification method according to claim 6, wherein
the detection step comprises judging whether the telemetry requirements request certainty and real-time property, and determining to notify the alternative controller of the telemetry information in the slice when the telemetry requirements request both the certainty and the real-time property.

9. The telemetry information notification method according to claim 6, wherein the determination step comprises judging whether the telemetry requirements request the certainty and the real-time property, and determining to notify the alternative controller of the telemetry information in the slice at a frequency lower than a notification frequency when a failure does not occur in the controller when the telemetry requirements request the certainty but do not request the real-time property.

10. The telemetry information notification method according to claim 8, further comprising:
a transmission step for transmitting the telemetry information and the telemetry requirements in the slice to another controller that is a candidate of the alternative controller when the determination step determines to notify the alternative controller of the telemetry information in the slice;
a reception step for receiving a notification indicating whether the other controller can operate as the alternative controller; and
a notification step for notifying the other controller of the telemetry information in the slice when the notification received by the reception step indicates that the other controller can operate as the alternative controller.

11. The telemetry information notification method according to claim 6, wherein
the determination step comprises judging whether the telemetry requirements request the certainty and the real-time property, and determining to store the telemetry information in the slice in a predetermined storage device when the telemetry requirements do not request both the certainty and the real-time property.

12. The non-transitory computer-readable storage medium according to claim 7, wherein
the detection procedure comprises judging whether the telemetry requirements request certainty and real-time property, and determining to notify the alternative controller of the telemetry information in the slice when the telemetry requirements request both the certainty and the real-time property.

13. The non-transitory computer-readable storage medium according to claim 7, wherein
the determination procedure comprises judging whether the telemetry requirements request the certainty and the real-time property, and determining to notify the alternative controller of the telemetry information in the slice at a frequency lower than a notification frequency when a failure does not occur in the controller when the telemetry requirements request the certainty but do not request the real-time property.

14. The non-transitory computer-readable storage medium according to claim 12, wherein the operations further comprise:
a transmission procedure for transmitting the telemetry information and the telemetry requirements in the slice to another controller that is a candidate of the alternative controller when the determination procedure determines to notify the alternative controller of the telemetry information in the slice;
a reception procedure for receiving a notification indicating whether the other controller can operate as the alternative controller; and
a notification step procedure notifying the other controller of the telemetry information in the slice when the notification received by the reception procedure indicates that the other controller can operate as the alternative controller.

15. The non-transitory computer-readable storage medium according to claim 7, wherein
the determination procedure comprises judging whether the telemetry requirements request the certainty and the real-time property, and determining to store the telemetry information in the slice in a predetermined storage device when the telemetry requirements do not request both the certainty and the real-time property.
